(19) United States
(12) Patent Application Publication
(10) Pub. No.: US 2004/0261071 A1
(43) Pub. Date: Dec. 23, 2004

(54) Peer version control system

(75) Inventors: Yu-Chen Chuang, Hsinchu (TW); Yi-Tien Chiang, Hsinchu (TW)

Correspondence Address: Finnegan, Henderson, Farabow,, Garrett & Dunner, L.L.P., 1300 I Street, N.W., Washington, DC, 20005-3315, US

(73) Assignee: Macronix International Co., Ltd.

(21) Appl. No.: 10/600,700

(22) Filed: Jun. 23, 2003

(51) Int. Cl. G06F 9/44; G06F 9/445; G06F 15/173

(52) U.S. Cl. 717/170; 717/176; 709/223

(57) ABSTRACT

A method of data control for a system server and a sub-network including a plurality of user terminals, the method comprising the steps of providing the system server with updated software versions, selecting one of the user terminals, requesting from the system server a list of the updated software versions that are absent in the selected user terminal, determining whether the unselected user terminals include any of the absent updated software versions, receiving the absent updated software versions to have been included in the unselected user terminals, receiving the absent updated software versions to have not been included in the unselected user terminals, and upgrading the selected user terminal with the received absent updated software versions.

### DESCRIPTION OF THE INVENTION

1. Field of the Invention

This invention relates in general to a software upgrade control system and, more particularly, to a peer-to-peer software upgrade control system.

2. Background of the Invention

Software programs such as operating systems or platforms have continuously been evolving to meet application requirements. To provide more powerful functions or support more comprehensive applications, new versions of a software program are invented to update old versions. Conventionally, the update of a software program may be implemented under a client-server structure wherein a system server downloads a new version of the program to a client through, for example, a file transfer protocol. However, for a semiconductor fab or a large company that may generally employ hundreds or even thousands of client computers, a system server has to download as many times as the number of client computers to complete the update. The conventional update structures may be economically ineffective and no longer acceptable because of heavy server loads and frequent server upgrades. Moreover, the failure to update or version confusion may occur in the conventional update structures, resulting in the degradation of system performance.

### SUMMARY OF THE INVENTION

Accordingly, the present invention is directed to a system that obviates one or more of the problems due to limitations and disadvantages of the related art.

To achieve these and other advantages, and in accordance with the purpose of the invention as embodied and broadly described, there is provided a method of software upgrade control for a system server and a sub-network including a plurality of user terminals, the method comprising the steps of providing the system server with updated software versions, selecting one of the user terminals, requesting from the system server a list of the updated software versions that are absent in the selected user terminal, determining whether the unselected user terminals include any of the absent updated software versions, receiving the absent updated software versions to have been included in the unselected user terminals, receiving the absent updated software versions to have not been included in the unselected user terminals, and upgrading the selected user terminal with the received absent updated software versions.

In one aspect, the method further comprises the step of broadcasting an inquiry in the sub-network in determining whether the unselected user terminals include any of the absent updated software versions.

In another aspect, the method further comprises the step of registering at the system server after requesting from the system server a list of the updated software versions that are absent in the selected user terminal.

Also in accordance with the present invention, there is provided a software upgrade control system that comprises a system server, a plurality of updated software versions provided at the system server, a sub-network including a plurality of user terminals wherein one of the user terminals is selected, a first client-server structure and a second client-server structure provided at the selected user terminals, a client provided in the first client-server structure for requesting from the system server a list of the updated software versions that are absent in the selected user terminal, a first server provided in the first client-server structure for receiving an inquiry broadcast by the unselected user terminals, a second server provided in the second client-server structure for transmitting one of the updated software versions to one of the unselected user terminals in response to the inquiry broadcast, a first client provided in the second client-server structure for requesting one of the absent updated software versions from the unselected user terminals, and a second client provided in the second client-server structure for requesting one of the absent updated software versions from the system server.

In one aspect, the system further comprises an agent provided in the selected user terminal in requesting the list of the absent updated software versions.

Still in accordance with the present invention, there is provided a software upgrade control system that comprises a system server that provides updated software versions, a plurality of user terminals grouped to form a sub-network, a first client-server structure formed in each user terminal to request from the system server a list of updated software versions that are absent in a user terminal, broadcast in the sub-network an inquiry as to whether any other user terminals have any updated software versions absent in the user terminal, and receive an inquiry broadcast by any other user terminals, a second client-server structure formed in each user terminal to transmit an updated software version to one of the other user terminals in response to an inquiry broadcast by the one of the other user terminals, receive an absent updated software version from one of other user terminals if the result of the inquiry broadcast by the user terminal shows that one of the other user terminals has the absent updated software version, and receive an absent updated software version from the system server if the result of the inquiry shows that no other user terminals have the absent updated software version, and an agent formed in each user terminal for data communication between the first and second client-server structures.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a schematic view of a software upgrade control system in accordance with one embodiment of the present invention;

FIG. 2 is a schematic architecture of a software upgrade control system in accordance with one embodiment of the present invention; and

FIG. 3 is a flow chart showing the steps of a method of software upgrade control in accordance with one embodiment of the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

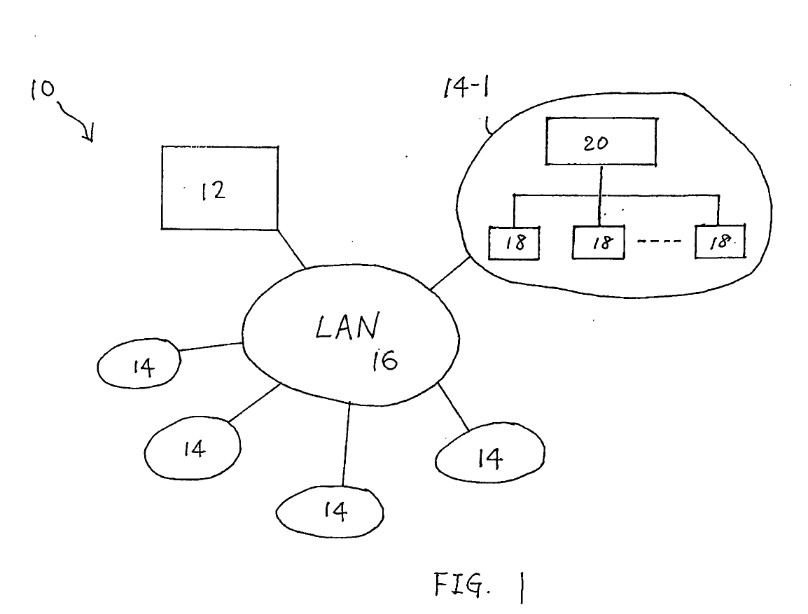

FIG. 1 shows a schematic view of a data control system 10 in accordance with one embodiment of the present invention. Referring to FIG. 1, data control system 10 includes a system server 12, at least one sub-network 14, and a local area network (“LAN”) 16 over which system server 12 communicates with at least one sub-network 14. A representative sub-network 14-1 includes a hub or switch router 20, and a plurality of user terminals 18 coupled to switch router 20 for communicating with system server 12. In one embodiment, user terminals coupled to a switch router are grouped to form a sub-network. System server 12 is provided with software programs such as operating systems, including their updated versions. Each user terminal 18 may include a personal computer, a notebook computer or a workstation computer.

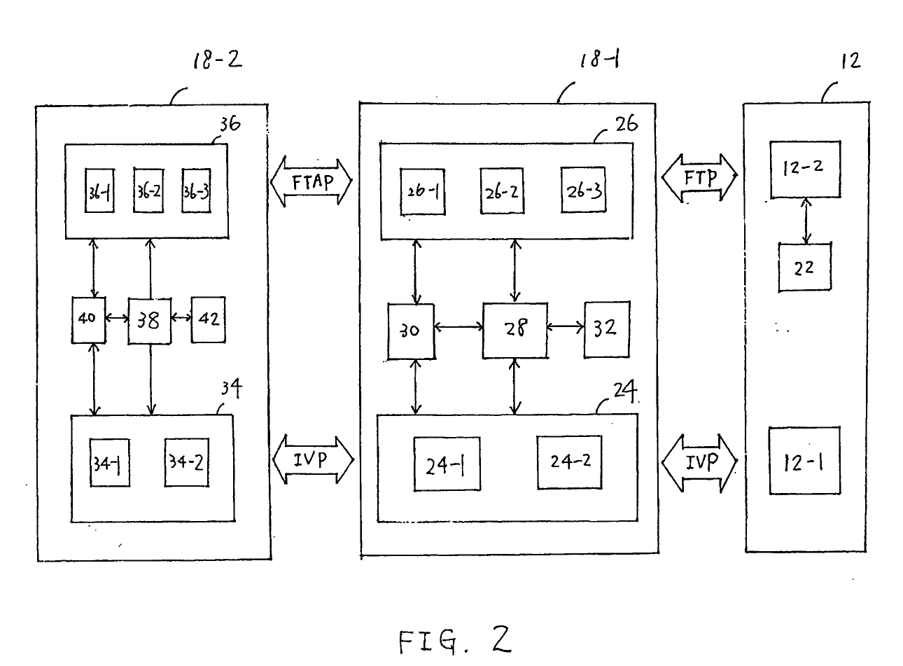

FIG. 2 shows a schematic architecture of data control system 10 in accordance with one embodiment of the present invention. Referring to FIG. 2, system server 12 includes a first server 12-1 and a second server 12-2. First server 12-1 provides a list of updated software versions that are absent from one of user terminals 18 upon a request made by that one user terminal 18. Second server 12-2 stores updated software versions in a storage 22, for example, a hard disc memory. A representative user terminal 18-1 includes a first client-server structure 24, a second client-server structure 26, and an agent 28. First client-server structure 24 includes a server 24-1 and a client 24-2. Second client-server structure 26 includes a server 26-1, a first client 26-2 and a second client 26-3. User terminal 18-1 may also include a first storage 30 for storing updated software versions in zipped form, and a second storage 32 for storing unzipped software versions after decompression.

A different user terminal 18-2 formed in the same sub-network as user terminal 18-1 includes generally the same structure as user terminal 18-1. User terminal 18-2 includes a first client-server structure 34, a second client-server structure 36, and an agent 38. First client-server structure 34 of user terminal 18-2 includes a server 34-1 and a client 34-2. Second client-server structure 36 of user terminal 18-1 includes a server 36-1, a first client 36-2 and a second client 36-3. User terminal 18-2 may also include a first storage 40 and a second storage 42. In one embodiment according to the present invention, first client-server structures 24 and 34, and first server 12-1 of system server 12 communicate with each other in an interversion protocol (“IVP”). The IVP includes a format for analyzing a received message, for example, an inquiry in network communication. Other protocols that support such a function may be used in the present invention to replace the IVP. Second clients 26-3 and 36-3 communicate with second server 12-2 of system server 12 in a file transfer protocol (“FTP”). The FTP is a typical protocol that supports file transfer among terminals. Servers 26-1 and 36-1, and first clients 26-2 and 36-2 communicate with each other in a file transfer assistant protocol (“FTAP”), which is a subset protocol of FTP.

In operation, agent 28, for example, a main program installed in user terminal 18-1, provides a service to start and read configuration files, and read the software versions currently installed in user terminal 18-1. Next, through client 24-2, agent 28 requests first server 12-1 to send a list of updated software versions, for example, updated versions of operating systems, that are absent from user terminal 18-1. If the request shows that no updated versions are absent, agent 28 registers with first server 12-1 through client 24-2 that a request for a list of updated software versions is made. If the request shows that at least one updated software version is absent, first server 12-1 then sends a list of the absent updated software versions in a format, for example, as follows.

P2P

1 = (458068) 0.0.1.1; (272278) 0.0.1.2;
2 = (301257) 0.0.0.8; (445876) 0.0.0.9;

wherein P2P indicates a peer-to-peer data transfer, i.e., an updated software version being available at a user terminal different from the requesting user terminal, which will hereinafter be described in further detail.

Agent 28 of user terminal 18-1 then analyzes the list sent from first server 12-2 in a form, for example, as shown in Table 1.

TABLE 1

| | | | | |
|---|---|---|---|---|
| Updated Software | 1 | 1 | 2 | 2 |
| No. | | | | |
| Software Name | SysA | SysA | SysB | SysB |
| Version | 0.0.1.1 | 0.0.1.2 | 0.0.0.8 | 0.0.0.9 |
| File Name | SysA- | SysA- | SysB- | SysB- |
| | 0.0.1.1.zip | 0.0.1.2.zip | 0.0.0.8.zip | 0.0.0.9.zip |
| Size (in bytes) | 458068 | 272278 | 301257 | 445876 |
| Download Method | FTP | P2P | FTP | P2P |
| Remote Server | | | | |
| Address | | | | |

According to Table 1, four updated software versions, SysA-0.0.1.1, SysA-0.0.1.2, SysB-0.0.0.8 and SysB-0.0.0.9 are absent from user terminal 18-1. Table 1 also reveals that among the four updated software versions, files SysA-0.0.1.2.zip and SysB-0.0.0.9.zip are suggested to be retrieved by a P2P download because they may be available at other user terminals. The other two files SysA-0.0.1.1.zip and SysB-0.0.0.8.zip are suggested to be retrieved by a default FTP download. In this particular embodiment, files SysA-0.0.1.2.zip and SysB-0.0.0.9.zip are the updated versions of files SysA-0.0.1.1.zip and SysB-0.0.0.8.zip, respectively.

User terminal 18-1 subsequently processes the FTP download. Second client 26-3 of second client-server structure 26 of user terminal 18-1 receives the FTP download files SysA-0.0.1.1.zip and SysB-0.0.0.8.zip shown in Table 1 from second server 12-2. To determine whether the downloaded zipped files SysA-0.0.1.1.zip and SysB-0.0.0.8.zip are correct, file size examination and cyclic redundancy check (“CRC”) may be performed.

Once all the FTP downloads are complete, user terminal 18-1 broadcasts through client 24-2 an inquiry over the sub-network including user terminal 18-1 as to which user terminals in the sub-network have at least one of the downloaded files SysA-0.0.1.2.zip and SysB-0.0.0.9.zip. The inquiry is received by the servers of the first client-server structures of other user terminals in the same sub-network. Assuming that user terminal 18-2 has the file SysA-0.0.1.2.zip, server 34-1 receives the inquiry and responds to user terminal 18-1 with its internet protocol (“IP”) address. Other servers of the first client-server structures of other user terminals provided with the file SysA-0.0.1.2.zip provide their addresses to user terminal 18-1. As a result, after broadcasting the inquiry, client 24-2 provides to agent 28 a reference list as given below to indicate at which addresses the file SysA-0.0.1.2.zip is available.

172.16.239.203; 172.16.239.237; 172.16.239.5;

In response to the reference list, agent 28 uses, for example, the first address 172.16.239.203, as a remote server address for downloading the file SysA-0.0.1.2.zip. Similarly, user terminal 18-1, in response to the reference list, uses at least one address, for example, 172.16.239.5, for downloading the file SysB-0.0.0.9.zip. The two addresses 172.16.239.203 and 172.16.239.5 are then filled in the remote server address column of Table 1 to form Table 2.

TABLE 2

| | | | | |
|---|---|---|---|---|
| Updated | 1 | 1 | 2 | 2 |
| Software No. | | | | |
| Software Name | SysA | SysA | SysB | SysB |
| Version | 0.0.1.1 | 0.0.1.2 | 0.0.0.8 | 0.0.0.9 |
| File Name | SysA- | SysA- | SysB- | SysB- |
| | 0.0.1.1.zip | 0.0.1.2.zip | 0.0.0.8.zip | 0.0.0.9.zip |
| Size (in bytes) | 458068 | 272278 | 301257 | 445876 |
| Download | FTP | P2P | FTP | P2P |
| Method | | | | |
| Remote Server | | 172.16.239.203 | | 172.16.239.5 |
| Address | | | | |

Next, first client 26-2 of second client-server structure of user terminal 18-1 receives the files SysA-0.0.1.2.zip and SysB-0.0.0.9.zip downloaded from the servers at addresses 172.16.239.203 and 172.16.239.5, respectively. In one embodiment according to the present invention, file size examination and CRC check are performed for the downloaded zipped files SysA-0.0.1.2.zip and SysB-0.0.0.9.zip to determine whether the files are correct. If the P2P download fails, the FTP download is then used to obtain a target file from system server 12. If errors are found in the process of the P2P download, second client-server structure 26 rolls back and automatically starts the P2P download after a predetermined period of time, for example, 10 minutes.

Once all the P2P downloads are complete, second client-server structure 26 updates a previous register by refreshing a list of software versions that are currently installed in user terminal 18-1 such that when server 24-1 receives an inquiry broadcast from other user terminals in the same sub-network, server 26-1 is able to download a specific updated software version to the other user terminals.

Next, agent 28 registers the version update with first server 12-1 through client 24-2. In one embodiment according to the present invention, first server 12-1 then sends information to agent 28 regarding a time interval, for example, one hour, to perform the version update process. Agent 28 again starts the process when the time interval has ended.

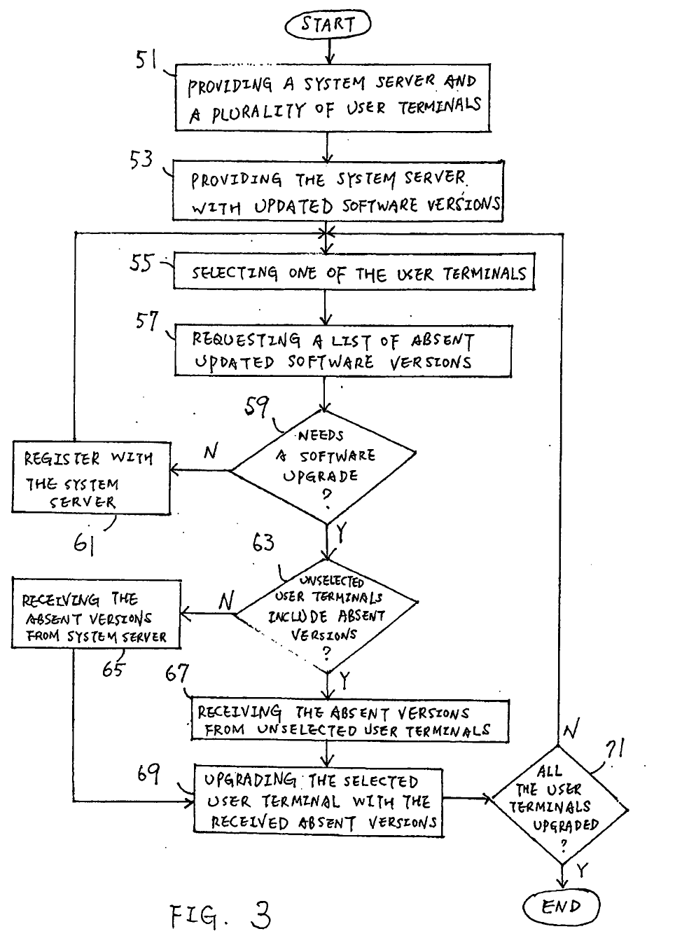

FIG. 3 is a flow chart showing the steps of a method of data control in accordance with one embodiment of the present invention. Referring to FIG. 3, the method begins with step 51 by providing a system server and a sub-network which includes a plurality of user terminals. Next, in step 53, the system server is provided with updated software versions, which in turn will be installed in the plurality of user terminals to facilitate network communication. In step 55, one of the user terminals is selected when a predetermined time interval for software version update has ended. Next, in step 57, the selected user terminal requests from the system server a list of the updated software versions that are absent in the selected user terminal.

Subsequent to step 57, in step 59, the method determines whether the selected user terminal needs a software upgrade. That is, if the request made in step 57 shows that no updated software versions are absent, the selected user terminal registers with the system server in step 61 that a request for a list of absent software versions is made. If the request shows that at least one updated software version is absent, the method then goes to step 63 and determines whether the remaining user terminals unselected in step 55 include any of the absent updated software versions. If none of the unselected user terminals include the absent updated software versions, in step 65, the selected user terminal receives the absent updated software versions from the system server. If any unselected user terminals include the absent updated software versions, then in step 67, the selected user terminal receives the absent updated software versions from one of the unselected user terminals.

Next, in step 69, the selected user terminal is upgraded with the received absent updated software versions, and refreshes a list of software versions currently installed therein. The selected user terminal then registers with the system server in step 61 that a request for a list of absent software versions is made.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of software upgrade control for a system server and a sub-network including a plurality of user terminals, the method comprising the steps of:
(a) providing said system server with updated software versions;
(b) selecting one of said user terminals;
(c) requesting from said system server a list of said updated software versions that are absent in said selected user terminal;
(d) determining whether those of said user terminals unselected in step (b) include any of said absent updated software versions;
(e) receiving those of said absent updated software versions determined in step (d) to have been included in said unselected user terminals;
(f) receiving those of said absent updated software versions determined in step (d) to have not been included in said unselected user terminals; and
(g) upgrading said selected user terminal with said received absent updated software versions.

2. The method of claim 1 further comprising the step of broadcasting an inquiry in said sub-network in determining whether said unselected user terminals include any of said absent updated software versions.

3. The method of claim 1 further comprising the step of registering at said system server after requesting from said system server a list of said updated software versions that are absent in said selected user terminal.

4. The method of claim 1 further comprising the step of providing an agent in said selected user terminal in requesting said list of said absent updated software versions.

5. The method of claim 1 further comprising the steps of:
receiving an inquiry broadcast by said unselected user terminals; and
transmitting one of said updated software versions in response to said inquiry broadcast.

6. The method of claim 1 wherein said selected user terminal is upgraded within a predetermined time interval.

7. The method of claim 1 further comprising the steps of:
providing said selected user terminal with a first client-server structure and a second client-server structure; and
providing a client in said first client-server structure for requesting said list of said absent updated software versions.

8. The method of claim 7 further comprising the steps of:
providing said first client-server structure with a first server for receiving an inquiry broadcast by said unselected user terminals; and
providing said second client-server structure with a second server for transmitting one of said updated software versions to one of said unselected user terminals in response to said inquiry broadcast.

9. The method of claim 7 further comprising the steps of:
providing said first client-server structure with a first client for requesting one of said absent updated software versions from said unselected user terminals; and
providing said second client-server structure with a second client for requesting one of said absent updated software versions from said system server.

10. A software upgrade control system comprising:
a system server;
a plurality of updated software versions provided at said system server;
a sub-network including a plurality of user terminals wherein one of said user terminals is selected;
a first client-server structure and a second client-server structure provided at said selected user terminals;
a client provided in said first client-server structure for requesting from said system server a list of said updated software versions that are absent in said selected user terminal;
a first server provided in said first client-server structure for receiving an inquiry broadcast by those of said user terminals that are unselected;
a second server provided in said second client-server structure for transmitting one of said updated software versions to one of said unselected user terminals in response to said inquiry broadcast;
a first client provided in said second client-server structure for requesting one of said absent updated software versions from said unselected user terminals; and
a second client provided in said second client-server structure for requesting one of said absent updated software versions from said system server.

11. The system of claim 10 further comprising an agent provided in said selected user terminal in requesting said list of said absent updated software versions.

12. The system of claim 10 wherein said system server supports an interversion protocol.

13. The system of claim 10 wherein said system server supports a file transfer protocol.

14. The system of claim 10 wherein said system server supports a file transfer assistant protocol.

15. The system of claim 10 further comprising an agent in each of said user terminals for data communication between said first client-server structure and said second client-server structure.

16. The system of claim 10 further comprising a local area network over which said system server communicates with each of said user terminals.

17. A software upgrade control system, comprising:
a system server that provides updated software versions;
a plurality of user terminals grouped to form a sub-network;
a first client-server structure formed in each of said user terminals to request from said system server a list of updated software versions that are absent, broadcast in said sub-network an inquiry as to whether any other user terminals have any updated software versions absent therein, and receive an inquiry broadcast by said other user terminals;
a second client-server structure formed in each of said user terminals to transmit one of said updated software versions to one of said other user terminals, receive an absent updated software version from one of said other user terminals having said absent updated software version, and receive an absent updated software version from said system server if no other user terminals has said absent updated software version; and
an agent formed in each of said user terminals for data communication between said first and second client-server structures.

18. The system of claim 17 wherein said first client-server structure formed in each of said user terminals communicates with said system server in an interversion protocol.

19. The system of claim 17 wherein said second client-server structure formed in each of said user terminals communicates with said system server in a file transfer protocol.

20. The system of claim 17 wherein said first client-server structure communicates with said other user terminals in an interversion protocol.

21. The system of claim 17 wherein said second client-server structure communicates with said other user terminals in a file transfer protocol.

22. The system of claim 17 further comprising a first storage for storing said updated software versions.

23. The system of claim 22 further comprising a second storage for storing said updated software versions that are unzipped.
